(19) United States
(12) Patent Application Publication
(10) Pub. No.: US 2015/0358195 A1
(43) Pub. Date: Dec. 10, 2015

(54) DIGITAL MODULATION METHOD AND APPARATUS, AND METHOD AND APPARATUS FOR PROVIDING MULTIPLE SERVICES USING SAID DIGITAL MODULATION

(71) Applicant: Electronics and Telecommunications Research Institute, Daejeon (KR)

(72) Inventors: Young Min KIM, Daejeon (KR); Heung Mook KIM, Daejeon (KR); Jae Hyun SEO, Daejeon (KR)

(21) Appl. No.: 14/734,928

(22) Filed: Jun. 9, 2015

(30) Foreign Application Priority Data
Jun. 10, 2014 (KR) 10-2014-0069855

(51) Int. Cl. H04L 27/34; H04L 1/00

(52) U.S. Cl. CPC H04L 27/3416; H04L 1/0034; H04L 1/0071

(57) ABSTRACT

The present invention discloses a digital modulation method for providing multiple services. The method for providing multiple services comprises multiplexing bits by allocating them according to a required SNR (Signal to Noise Ratio) of each service; and modulating multiplexed bits by applying non-uniform distances among constellation symbols.

### CROSS-REFERENCE TO RELATED APPLICATIONS

This application claims the benefit of priority of Korean Patent Application No. 10-2014-0069855 filed on Jun. 10, 2014, all of which are incorporated by reference in their entirety herein.

### BACKGROUND OF THE INVENTION

1. Field of the Invention

The present invention is related to a modulation method and apparatus; and more particularly, a digital modulation method and apparatus for providing multiple services.

2. Discussion of the Related Art

The conventional bit division multiplexing method subdivides a service in units of bits, thereby allowing individual services to have the respective SNRs (Signal to Noise Ratios). However, since the bit division method cannot provide performance beyond the most significant bit (MSB) and the required SNR varies among services according to the subdivision method employed, it is difficult to achieve the performance and the required SNR in an arbitrary manner.

### SUMMARY OF THE INVENTION

The present invention has been made in an effort to provide a digital modulation method for multiple services, which improves performance of a service with a low SNR requirement by applying digital modulation supporting non-uniform constellation to the bit division multiplexing method to cope flexibly with SNR requirements of bit-division multiple services and allocating services to the MSBs; and a method and an apparatus for providing multiple services by using the digital modulation method.

To achieve the objective above, a digital modulation method for multiple services according to the present invention can comprise multiplexing bits by allocating them according to a required SNR (Signal to Noise Ratio) of each service and modulating multiplexed bits by applying non-uniform distances among constellation symbols.

The multiplexing can comprise subdividing information related to the multiple services in units of bits by using the property that an inter-bit error probability within one symbol varies from one another.

The multiplexing can comprise allocating a service with a relatively low SNR requirement among the multiple services to the MSB while allocating a service with relatively high SNR requirement to the LSB (Least Significant Bit).

The modulating can comprise varying required SNR of a multiplexed service by using the non-uniform constellation.

In the mathematical equation below (where α represents a value used to make non-uniform constellation; β a value for normalizing average power of symbols; Es symbol power; and N0 noise power), the inter-bit error probability can be set differently by adjusting the α value.

$$β = \sqrt{\frac{{E}_{s}}{{N}_{0} \frac{{( 3 - α )}^{2} + {( 1 + α )}^{2}}{2 }}} .$$

To enhance the performance of the MSB of bit division multiplexing, the α value can be controlled to be larger than a reference value, and the α value can be controlled to be smaller than a reference value to enhance the performance of the LSB of bit division multiplexing.

The digital modulation method can further comprise performing error correction encoding for the individual multiple service-related signals and performing bit interleaving for each error correction encoded signal.

To achieve the objective above, a digital modulation apparatus for providing multiple services according to the present invention can comprise a multiplexer multiplexing bits by allocating them according to a required SNR (Signal to Noise Ratio) of each service and a modulator modulating multiplexed bits by applying non-uniform distances among constellation symbols.

The multiplexer can subdivide information related to the multiple services in units of bits by using the property that an inter-bit error probability within one symbol varies from one another.

The multiplexer can allocate a service with a relatively low SNR requirement among the multiple services to the MSB while allocating a service with relatively high SNR requirement to the LSB.

The modulator can vary required SNR of a multiplexed service by using the non-uniform constellation.

In the mathematical equation below (where α represents a value used to make non-uniform constellation; β a value for normalizing average power of symbols; Es symbol power; and N0 noise power), the multiplexer can set the inter-bit error probability differently by adjusting the α value.

$$β = \sqrt{\frac{{E}_{s}}{{N}_{0} \frac{{( 3 - α )}^{2} + {( 1 + α )}^{2}}{2 }}} .$$

To enhance the performance of the MSB of bit division multiplexing, the multiplexer can control the α value to be larger than a reference value and can control the α value to be smaller than a reference value to enhance the performance of the LSB of bit division multiplexing.

The digital modulation apparatus can further comprise an error correction encoder(s) performing error correction encoding for the individual multiple service-related signals and an interleaver(s) performing bit interleaving for each error correction encoded signal.

To achieve the objective above, an apparatus for providing multiple services according to the present invention can comprise an input unit receiving at least one service signal related to multiple services; an error correction encoding unit carrying out error correction encoding for the at least one service signal; a bit interleaver carrying out bit interleaving for the error correction encoded service signal; a multiplexer carrying out multiplexing by assigning a bit to the at least one bit-interleaved service signal according to a required SNR of each service; a modulator carrying out modulation by applying non-uniform distances among constellation symbols with respect to multiplexed bits; and a transmitter transmitting modulated symbols to a receiver side.

The multiplexer can carry out multiplexing by subdividing information related to the multiple services in units of bits by using the property that an inter-bit error probability within one symbol varies from one another.

The multiplexer can allocate a service with a relatively low SNR requirement among the multiple services to the MSB while allocating a service with a relatively high SNR requirement to the LSB.

The modulator can vary required SNR of a service by using the non-uniform constellation.

In the mathematical equation below (where α represents a value used to make non-uniform constellation; β a value for normalizing average power of symbols; Es symbol power; and N0 noise power), the modulator can set the inter-bit error probability differently by adjusting the α value.

$$β = \sqrt{\frac{{E}_{s}}{{N}_{0} \frac{{( 3 - α )}^{2} + {( 1 + α )}^{2}}{2 }}} .$$

To enhance the performance of the MSB of bit division multiplexing, the modulator can control the α value to be larger than a reference value and can control the α value to be smaller than a reference value to enhance the performance of the LSB of bit division multiplexing.

### BRIEF DESCRIPTION OF THE DRAWINGS

FIG. 1 is a flow diagram briefly illustrating a digital modulation method for providing multiple services according to one embodiment of the present invention.

FIG. 2 illustrates a time division multiplexing method.

FIG. 3 illustrates a bit division multiplexing method according to one embodiment of the present invention.

FIG. 4 illustrates an apparatus for providing multiple services through a digital modulation method according to one embodiment of the present invention.

FIG. 5 illustrates 16-QAM constellation along in-phase axis in an embodiment of a digital modulator providing non-uniform constellation according to the present invention.

FIG. 6 illustrates constellation of 16 QAM in the first quadrant employing non-uniform constellation according to α value of the present invention.

FIG. 7 illustrates performance of multiple services varying according to α value in the 16-QAM digital modulation scheme having non-uniform constellation.

### DETAILED DESCRIPTION OF THE INVENTION

The present invention can be modified in various ways, and various embodiments can be implemented; therefore, particular embodiments are described in detail with reference to accompanying drawings.

This document is not limited to the particular embodiments, but it should be understood that descriptions of this document are applied to all the possible modifications, equivalents, or substitutes which belong to the technical principles and scope of the present invention.

Terms such as first and second can be used for describing various constituting elements but the constituting elements should not be limited by the terms. The terms are introduced only for the purpose of distinguishing one constituting element from the others. For example, a first constituting element may be called a second constituting element without departing from the scope of the present invention and vice versa. Meanwhile, the term of and/or refers to a combination of a plurality of related specific elements or any one of a plurality of related specific elements.

If an element is said to be “linked” or “connected” to a different element, the element may be directly linked or connected to the different element, but a third element may exist to connect the two elements. On the other hand, if an element is said to be “directly linked” or “directly connected” to a different element, it should be understood that no other element lies between the two elements.

Terms used in this document have been introduced only for the purpose of describing particular embodiments but are not intended to limit the present invention. Singular expressions, unless otherwise indicated explicitly, can be used for plural expressions. It should be understood that such terms as “comprise” or “have” in this document are meant to indicate existence of characteristics, numerals, steps, operations, constituting elements, components or a combination thereof, but do not preclude existence or additional possibility of one or more characteristics, numerals, steps, operations, constituting elements, components, or a combination thereof.

Unless otherwise defined, all of the terms used in this document, including technical or scientific ones, carry the same meaning as understood by those skilled in the art to which the present invention belongs. Those terms as defined in an ordinary dictionary should be interpreted to hold the same meaning as contextually indicated by the corresponding technology; therefore, unless otherwise defined explicitly, they should not be interpreted in an ideal manner or in an excessive formality.

In what follows, with reference to appended drawings, preferred embodiments of the present invention will be described in more detail. To facilitate the overall understanding of the present invention, the same reference symbols are used for the same constituting elements used throughout the drawings, and descriptions about the same constituting elements will be omitted.

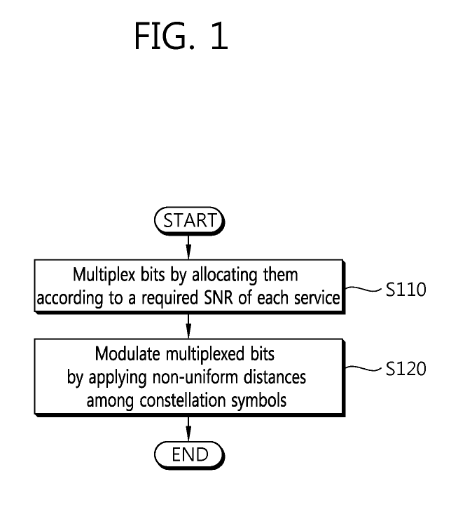

FIG. 1 is a flow diagram briefly illustrating a digital modulation method for providing multiple services according to one embodiment of the present invention.

With reference to FIG. 1, a digital modulation apparatus carries out multiplexing by assigning bits according to required SNRs of individual services S110. The apparatus can receive a different signal for each service. Each service has its own required SNR (Signal to Noise Ratio), and the service is provided according to the corresponding required SNR. For example, a public and a cable TV broadcast service have different target audiences; therefore, required SNRs for the respective broadcast services may differ from each other. Although the present invention is focused on the SNR only, similar concepts such as PSNR (Peak Signal to Noise Ratio) or noise performance can also be taken into account selectively. Each service is allocated to an appropriate bit according to the SNR required for the service, which is called bit division multiplexing (BDM). In what follows, bit division multiplexing according to the present invention is described with respect to the time division multiplexing (TDM).

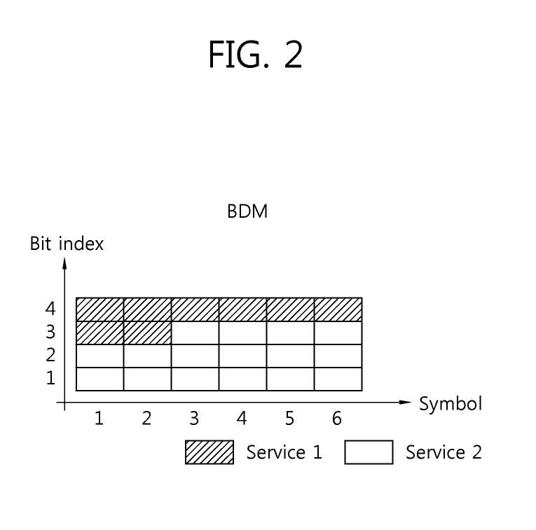

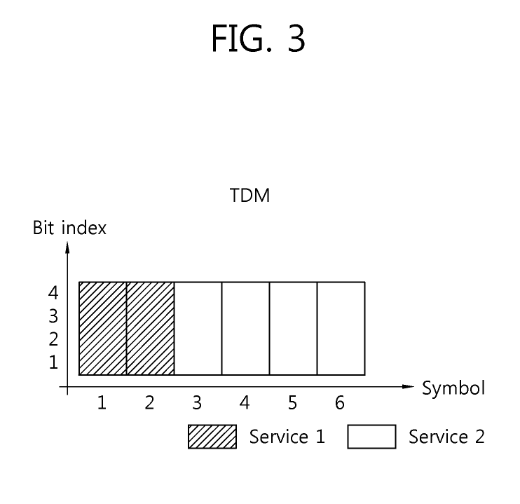

FIG. 2 illustrates a time division multiplexing method, and FIG. 3 illustrates a bit division multiplexing method according to one embodiment of the present invention.

With reference to FIGS. 2 and 3, the time division multiplexing transmits a service by dividing the service into different time slots, which can be easily implemented, and since a receiver only needs to detect the part allocated for receiving the service, the resultant complexity can be kept small (see FIG. 2). Differently from the time division multiplexing, bit division multiplexing provides multiple services by subdividing the multiple services in units of bits based on the property that an inter-bit error probability differs from each other within one symbol (see FIG. 3).

According to one embodiment of the present invention, each bit has a different error probability in a digital modulation method; therefore, each individual service can be subdivided in units of bits, including the MSB or the LSB, according to its required SNR. For example, SNR requirements can be met among various services to be provided by allocating a service having a low SNR requirement usually to the MSB while a service with a high SNR requirement usually to the LSB. On the contrary, a service with a high SNR requirement may be allocated to the LSB while a service with a low SNR requirement may be allocated to the MSB. The high and low of a required SNR can be determined through relative comparison of SNRs among multiplexed services. For example, when a plurality of services are multiplexed, required SNRs thereof are arranged and their sizes are compared to one another based on whether the required SNRs belong to high ranks or lower ranks; and by allocating bits according to the comparison result, SNRs required for the respective services can be met.

According to an embodiment of the present invention, error correction encoding and interleaving process can be applied separately to individual services before bit division multiplexing is carried out. After the error correction encoding and the interleaving process is carried out for each service signal, the bit division multiplexing can be carried out to the service signal and an appropriate bit can be allocated to the service signal.

Referring again to FIG. 1, after bit division multiplexing is carried out, the apparatus carries out modulation by applying non-uniform constellation with respect to a multiplexed bit S120. The multiplexed bit has to be modulated to be processed as one symbol; according to the present invention, it is preferable that the modulation should be carried out through a non-uniform digital modulation scheme which makes distances among symbols non-uniform. Since bit division multiplexing is applied according to a required SNR of each service, the modulation should be carried out so that performance can be changed according to the degree of non-uniformity by re-adjusting the required SNR of a bit allocated to the corresponding service. In the conventional modulation method employing uniform constellation, bit division multiplexing has been used, and in this case, the only way to improve performance of the MSB is to keep the encoding rate of error correction codes to a small value. However, modulation through non-uniform constellation according to the present invention can improve performance of the MSB, thereby enabling a service with a low SNR requirement to be provided. In other words, since optimized constellation varies according to SNR, the SNR should be determined according to a required SNR of the corresponding system; since the error probability becomes 0 for those SNR values larger than a predetermined value due to the capability of the error correction codes in the conventional method, the performance with regard to a required SNR of a system determines the system performance. Therefore, the system performance can be improved by optimizing non-uniform constellation at a required SNR.

According to an embodiment of the present invention, such a non-uniform constellation modulation method can be used for various digital modulation methods such as QPSK (Quadrature Phase Shift Keying) or 64-QAM (Quadrature Amplitude Modulation) as well as 16-QAM.

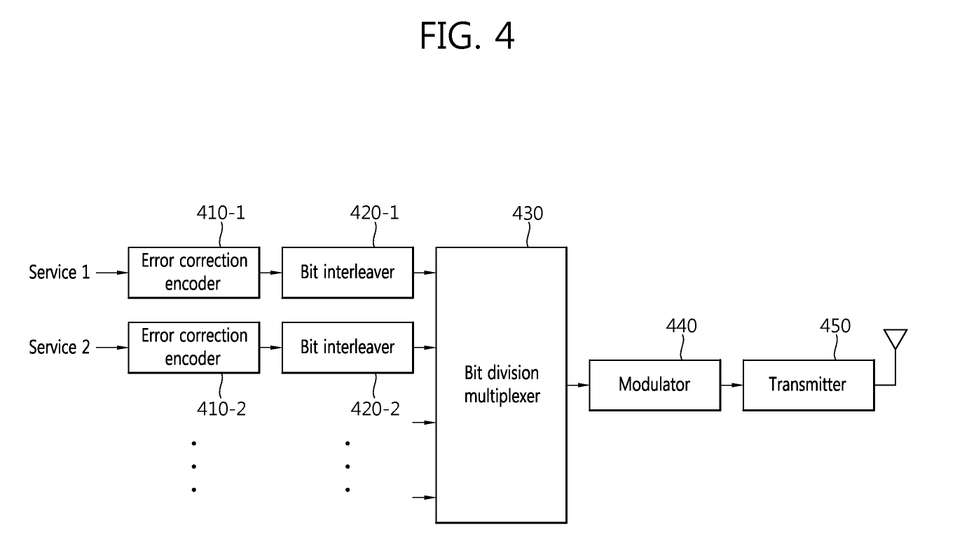

FIG. 4 illustrates an apparatus for providing multiple services through a digital modulation method according to one embodiment of the present invention. As shown in FIG. 4, an apparatus for providing multiple services through digital modulation according to one embodiment of the present invention can comprise error correction encoders 410-1, 410-2, . . . , 410-N, bit interleavers 420-1, 420-2, . . . , 420-N, a bit division multiplexer 430, a modulator 440, and a transmitter 450.

With reference to FIG. 4, individual service signals are processed by error correction encoders 410-1, 410-2, . . . , 410-N and bit interleavers 420-1, 420-2, . . . , 420-N, separately from each other. In other words, a service 1 signal is processed by the error correction encoder 410-1 and a bit interleaver 420-1, after which the processed signal is provided to the bit division multiplexer 430, while a service 2 signal is processed by an error correction encoder 410-2 and a bit interleaver 420-2 and the processed signal is provided to the bit division multiplexer 430. The error correction encoders 410-1, 410-2, . . . , 410-N carry out error correction encoding of the corresponding service signals. The error correction encoders 410-1, 410-2, . . . , 410-N can carry out encoding based on block code and convolutional code. The error correction encoders 410-1, 410-2, . . . , 410-N can carry out error correction encoding based on various codes; according to an embodiment of the present invention, turbo encoding through iterative decoding and low density parity coding (LDPC) can be used. The bit interleavers 420-1, 420-2, . . . , 420-N carry out bit interleaving on each error correction encoded service signal separately from each other. According to one embodiment of the present invention, the bit interleavers 420-1, 420-2, . . . , 420-N can carry out interleaving through a split convolutional interleaving scheme which has a particular period in units of bits. Through this interleaving, burst error correction capability can be enhanced a lot.

Individual service signals which have passed through the bit interleavers 420-1, 420-2, . . . , 420-N are provided to the bit division multiplexer 430. As described above, the bit division multiplexer 430 carries out multiplexing by allocating a bit adaptively according to a required SNR of each service signal. In other words, since an error probability differs from bit to bit, bit division can be carried out for each service according to the required SNR of the service, including the MSB or the LSB.

The modulator 440 carries out digital modulation having non-uniform constellation to process the bits multiplexed through the bit division multiplexer 430 as one symbol. The modulator 440, which is intended to improve performance by transforming constellation symbols having uniform distances among them in the conventional digital modulation into those having non-uniform distances, is mostly used for improving performance; however, the modulator according to the present invention can be used to change required SNRs of bit-multiplexed services.

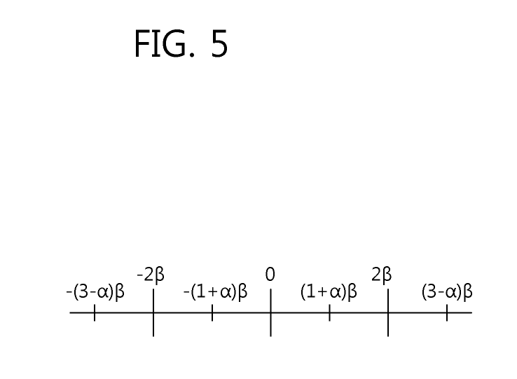

FIG. 5 illustrates 16-QAM constellation along in-phase axis in an embodiment of a digital modulator 440 providing non-uniform constellation according to the present invention.

According to FIG. 5, related to the non-uniform constellation of the modulator 440, α value is intended to make non-uniform constellation, and β is a value for normalizing average power of a symbol, the relationship of which is shown in the following mathematical equation.

$$β = \sqrt{\frac{{E}_{s}}{{N}_{0} \frac{{( 3 - α )}^{2} + {( 1 + α )}^{2}}{2 }}} , \qquad [ Eq . 1 ]$$

where Es represents symbol power and N0 represents noise power.

In the equation above, if α=0, the equation becomes the same as the expression for the conventional 16-QAM having uniform constellation, and according to the α value, the degree of non-uniformity is determined as shown in FIG. 5.

According to an embodiment of the present invention, if bit b1 and b3 transmit 00, the error probability of b1 takes on a value in the region of which the coordinate value is smaller than 0 on the in-phase axis, while the error probability of b3 is determined by the value in the region of which the coordinate value is smaller than 2β on the in-phase axis with respect to (3−α)β, but if the coordinate value drops further below −2β, the error becomes zero again. Also, if bit b1 and b3 transmit 01, the error probability of b1 again takes on a value in the region of which the coordinate value is smaller than 0 on the in-phase axis, while the error probability of b3 is determined by the value in the regions of which the coordinate value is larger than 2β and the coordinate value is smaller than −2β on the in-phase axis. To interpret the description above mathematically, since the same error probability is obtained for 00 and 01 when b1 and b3 transmit 10 and 11 respectively, the final error probability of non-uniform constellation 16-QAM can be obtained by using the error probability for 00 and 01.

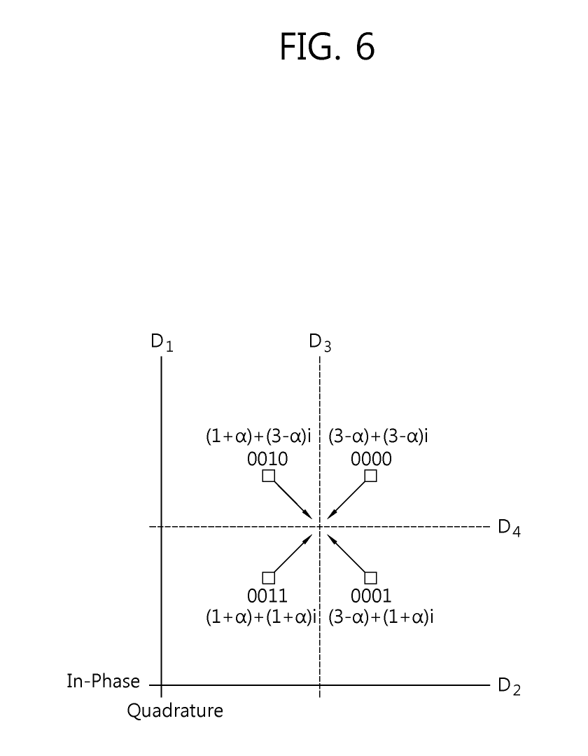

FIG. 6 illustrates constellation of 16 QAM in the first quadrant employing non-uniform constellation according to α value of the present invention.

With reference to FIG. 6, if non-uniform constellation modulation according to one embodiment of the present invention is applied, the inter-bit error probability is changed according to the α value, by which the required SNRs of bit division multiple services can be changed accordingly to achieve the objective of the present invention.

Referring again to FIG. 4, the transmitter 450 transmits a multiplexed and modulated multiple service signal to a receiver side. The transmitter 450 can transmit the service signal to the receiver side through wireless or wired communication, and at least one of a TV network and a communication network can be employed.

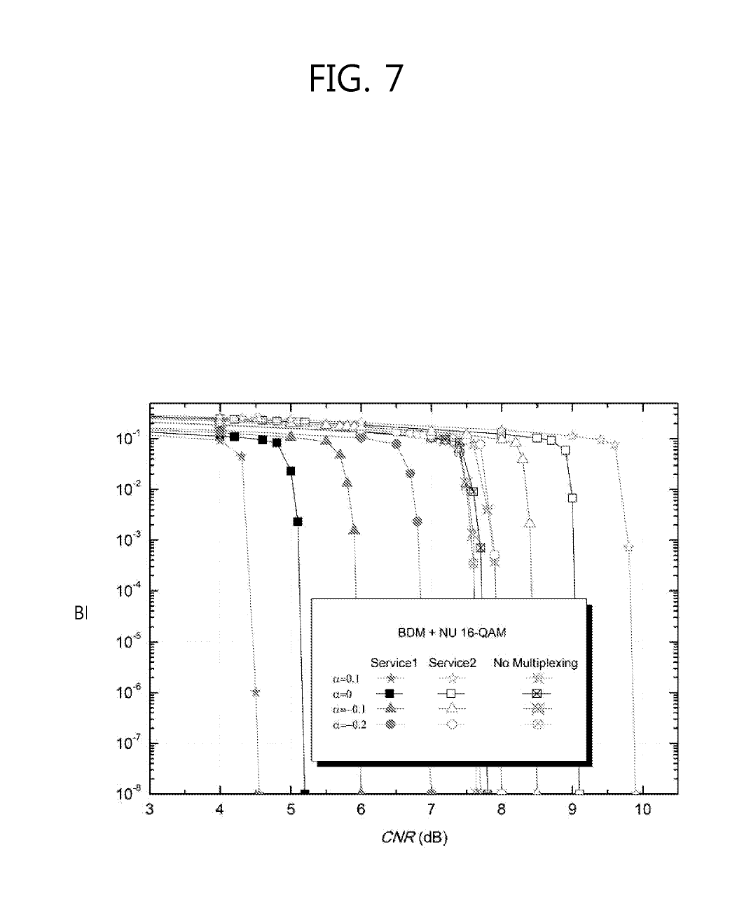

FIG. 7 illustrates performance of multiple services varying according to α value in the 16-QAM digital modulation scheme having non-uniform constellation. Referring to FIG. 7, for a simulated experiment, Service 1 is allocated to the MSB of 16-QAM, and Service 2 is allocated to the LSB of the 16-QAM. Also, an error correction code uses LDPC of the DVB-T2 having ⅗ encoding rate, and is iterated 50 times for decoding.

As shown in FIG. 7, performance of services multiplexed by bit division is changed according to the degree of non-uniformity of NU-QAM (Non-Uniform QAM). As shown in FIG. 4, if the α value becomes smaller than 0, performance of the LSB deteriorates whereas that of the MSB is improved. Similarly, if the α value becomes smaller than 0, performance of the LSB is improved whereas that of the MSB deteriorates. By using this fact, the required SNR of a bit multiplexed service can be changed appropriately. As described above, in the conventional modulation method employing uniform constellation, bit division multiplexing has been used, and in this case, the only way to improve performance of the MSB at the time of using bit division multiplexing is to keep the encoding rate of error correction codes to a small value; however, the present invention improves performance of the MSB so that a service with a low SNR requirement can be provided. Although embodiments of the present invention assume that NU 16-QAM is employed, the present invention is not limited to the NU 16-QAM. A bit division ratio or a method of non-uniform constellation may be different from what are provided by the present invention; however, it should be clearly understood by those skilled in the art to which the present invention belongs that various substitutions and modifications of the present invention are allowed as long as they belong to the technical scope of the present invention.

The present invention has been described with reference to accompanying drawings and embodiments; however, the technical scope of the present invention is not limited to what is defined by the drawings or embodiments, and it should be understood by those skilled in the art that the present invention can be modified or revised in various ways without departing from the technical principles and scope of the present invention defined by the appended claims.

According to a digital modulation method for providing multiple services and one method and apparatus for providing multiple service by using the digital modulation method of the present invention, required SNRs of multiplexed services can be changed easily by using NU-QAM when a bit division multiplexing is employed.

Also, while there are limitations for improving performance of a service allocated to the MSB in a digital modulation method providing conventional uniform constellation, the present invention is capable of overcoming the limitations.

What is claimed is:

1. A digital modulation method for providing multiple services, comprising:
multiplexing bits by allocating the bits according to a required SNR (Signal to Noise Ratio) of each service; and
modulating the multiplexed bits by applying non-uniform distances among constellation symbols.

2. The method of claim 1, wherein the multiplexing comprises subdividing information related to the multiple services in units of bits by using the property that an inter-bit error probability within one symbol varies from one another.

3. The method of claim 2, wherein the multiplexing comprises allocating a service with relatively low SNR requirement among the multiple services to MSB (Most Significant Bit) while allocating a service with relatively high SNR requirement to the LSB (Least Significant Bit).

4. The method of claim 1, wherein the modulating comprises varying required SNR of a multiplexed service by using the non-uniform constellation.

5. The method of claim 1, wherein an inter-bit error probability is set differently by adjusting α value in a mathematical equation below (where α represents a value used to make non-uniform constellation; β a value for normalizing average power of symbols; Es symbol power; and N0 noise power).
$$β = \sqrt{\frac{{E}_{s}}{{N}_{0} \frac{{( 3 - α )}^{2} + {( 1 + α )}^{2}}{2 }}} .$$

6. The method of claim 1, wherein, to enhance performance of MSB of bit division multiplexing, the α value is controlled to be larger than a reference value, and
the α value is controlled to be smaller than a reference value to enhance performance of LSB of bit division multiplexing.

7. The method of claim 1, further comprising
performing error correction encoding for the individual multiple service-related signals; and
performing bit interleaving for each error correction encoded signal.

8. A digital modulation apparatus for providing multiple services, comprising:
a multiplexer configured to multiplex bits by allocating the bits according to a required SNR (Signal to Noise Ratio) of each service; and
a modulator configured to modulate multiplexed bits by applying non-uniform distances among constellation symbols.

9. The apparatus of claim 8, wherein the multiplexer is configured to subdivide information related to the multiple services in units of bits by using the property that an inter-bit error probability within one symbol varies from one another.

10. The apparatus of claim 9, wherein the multiplexer is configured to allocate a service with relatively low SNR requirement among the multiple services to MSB (Most Significant Bit) while the multiplexer is configured to allocate a service with relatively high SNR requirement to the LSB (Least Significant Bit).

11. The apparatus of claim 8, wherein the modulator is configured to vary required SNR of a multiplexed service by using the non-uniform constellation.

12. The apparatus of claim 8, wherein an inter-bit error probability is set differently by adjusting α value in a mathematical equation below (where α represents a value used to make non-uniform constellation; β a value for normalizing average power of symbols; Es symbol power; and N0 noise power)
$$β = \sqrt{\frac{{E}_{s}}{{N}_{0} \frac{{( 3 - α )}^{2} + {( 1 + α )}^{2}}{2 }}} .$$

13. The apparatus of claim 12, wherein, to enhance performance of MSB of bit division multiplexing, the multiplexer is configured to control the α value to be larger than a reference value and
to control the α value to be smaller than a reference value to enhance the performance of the LSB of bit division multiplexing.

14. The apparatus of claim 8, further comprising
an error correction encoder(s) configured to perform error correction encoding for the individual multiple service-related signals; and
an interleaver(s) configured to perform bit interleaving for each error correction encoded signal.

15. An apparatus for providing multiple services, comprising:
an input unit configured to receive at least one service signal related to multiple services;
an error correction encoding unit configured to carry out error correction encoding for the at least one service signal;
a bit interleaver configured to carry out bit interleaving for the error correction encoded service signal;
a multiplexer configured to carry out multiplexing by assigning a bit to the at least one bit-interleaved service signal according to a required SNR of each service;
a modulator configured to carry out modulation by applying non-uniform distances among constellation symbols with respect to multiplexed bits; and
a transmitter configured to transmit modulated symbols to a receiver side.

16. The apparatus of claim 15, wherein the multiplexer is configured to carry out multiplexing by subdividing information related to the multiple services in units of bits by using the property that an inter-bit error probability within one symbol varies from one another.

17. The apparatus of claim 16, wherein the multiplexer is configured to allocate a service with a relatively low SNR requirement among the multiple services to MSB while the multiplexer is configured to allocate a service with a relatively high SNR requirement to LSB (Least Significant Bit).

18. The apparatus of claim 15, wherein the modulator is configured to vary required SNR of a service by using the non-uniform constellation.

19. The apparatus of claim 15, wherein the modulator is configured to set inter-bit error probability differently by adjusting α value in a mathematical equation below (where α represents a value used to make non-uniform constellation; β a value for normalizing average power of symbols; Es symbol power; and N0 noise power)
$$β = \sqrt{\frac{{E}_{s}}{{N}_{0} \frac{{( 3 - α )}^{2} + {( 1 + α )}^{2}}{2 }}} .$$

20. The apparatus of claim 19, wherein, to enhance performance of MSB of bit division multiplexing, the modulator is configured to control the α value to be larger than a reference value and the modulator is configured to control the α value to be smaller than a reference value to enhance performance of LSB of bit division multiplexing.
